(19) United States
(12) Patent Application Publication
(10) Pub. No.: US 2025/0104175 A1
(43) Pub. Date: Mar. 27, 2025

(54) SYSTEM AND METHOD FOR UTILIZING PREPAID CARDS TO FACILITATE PURCHASES IN ASSOCIATION WITH A GAMING ESTABLISHMENT RETAIL ACCOUNT

(71) Applicant: IGT, Las Vegas, NV (US)

(72) Inventors: Kevin Higgins, Reno, NV (US); Jeffery Shepherd, Reno, NV (US)

(21) Appl. No.: 18/975,866

(22) Filed: Dec. 10, 2024

Related U.S. Application Data
(63) Continuation of application No. 16/579,221, filed on Sep. 23, 2019.

(51) Int. Cl. G06Q 50/34; G06Q 20/20; G06Q 20/28; G06Q 20/34; G06Q 20/40; G07F 17/32; H04M 17/00

(52) U.S. Cl. CPC G06Q 50/34; G06Q 20/20; G06Q 20/28; G06Q 20/342; G06Q 20/405; G07F 17/32; G07F 17/3244; H04M 17/005

(57) ABSTRACT

A system and method that utilizes funds associated with one or more gaming establishment accounts maintained for a user to procure one or more pre-paid cards associated with a retailer and used to complete one or more purchases of goods and/or services from the retailer. To facilitate the use of pre-paid cards, the system and method automatically issues (if needed) and funds one or more pre-paid cards which are then used by the system to complete a retail purchase.

### PRIORITY CLAIM

This application is a continuation of, claims the benefit of and priority to U.S. patent application Ser. No. 16/579,221, filed on Sep. 23, 2019, the entire contents of which is incorporated by reference herein.

### TECHNICAL FIELD

The technical field of the present disclosure is that of systems and methods that utilize funds associated with one or more gaming establishment accounts maintained for a user to procure one or more pre-paid cards associated with a retailer and used to complete one or more purchases of goods and/or services from the retailer.

### BACKGROUND

Gaming machines may provide players awards in primary games. Gaming machines generally require the player to place a wager to activate the primary game. The award may be based on the player obtaining a winning symbol or symbol combination and on the amount of the wager.

### BRIEF SUMMARY

In certain embodiments, the present disclosure relates to a system including a processor, and a memory device that stores a plurality of instructions. When executed by the processor in association with a purchase at a point-of-sale terminal of a retail system, the instructions cause the processor to determine, based on a predetermined pre-paid card spending amount limit, a first quantity of pre-paid cards. When executed by the processor as a result of a gaming establishment account not being associated with the determined first quantity of pre-paid cards, the instructions cause the processor to automatically associate a second quantity of pre-paid cards with the gaming establishment account such that the gaming establishment account is associated with at least the determined first quantity of pre-paid cards, and transfer an amount of funds associated with the purchase from the gaming establishment account to the determined first quantity of pre-paid cards, wherein no more than the predetermined pre-paid card spending amount limit is transferred to any one of the determined first quantity of pre-paid cards.

In certain embodiments, the present disclosure relates to a system including a processor, and a memory device that stores a plurality of instructions. When executed by the processor in association with a purchase at a point-of-sale terminal of a retail system, the instructions cause the processor to determine, based on a predetermined pre-paid card spending amount limit, a first quantity of pre-paid cards, and determine a second quantity of pre-paid cards associated with a gaming establishment account. When executed by the processor as a result of the second quantity of pre-paid cards associated with the gaming establishment account being greater than the determined first quantity of pre-paid cards, the instructions cause the processor to select the determined first quantity of pre-paid cards from the second quantity of pre-paid cards associated with the gaming establishment account, and transfer an amount of funds associated with the purchase from the gaming establishment account to the determined first quantity of pre-paid cards, wherein no more than the predetermined pre-paid card spending amount limit is transferred to any one of the determined first quantity of pre-paid cards. When executed by the processor as a result of the second quantity of pre-paid cards associated with the gaming establishment account being equal to the determined first quantity of pre-paid cards, the instructions cause the processor to transfer the amount of funds associated with the purchase from the gaming establishment account to the determined first quantity of pre-paid cards, wherein no more than the predetermined pre-paid card spending amount limit is transferred to any one of the determined first quantity of pre-paid cards. When executed by the processor as a result of the second quantity of pre-paid cards associated with the gaming establishment account being less than the determined first quantity of pre-paid cards, the instructions cause the processor to automatically associate a third quantity of pre-paid cards with the gaming establishment account such that the gaming establishment account is associated with the determined first quantity of pre-paid cards, and transfer the amount of funds associated with the purchase from the gaming establishment account to the determined first quantity of pre-paid cards, wherein no more than the predetermined pre-paid card spending amount limit is transferred to any one of the determined first quantity of pre-paid cards.

In certain embodiments, the present disclosure relates to a method of operating a system that includes, as a result of a purchase at a point-of-sale terminal of a retail system, determining, by a processor and based on a predetermined pre-paid card spending amount limit, a first quantity of pre-paid cards. As a result of a gaming establishment account not being associated with at least the determined first quantity of pre-paid cards, the method includes automatically associating, by the processor, a second quantity of pre-paid cards with the gaming establishment account such that the gaming establishment account is associated with at least the determined first quantity of pre-paid cards, and transferring, by the processor, an amount of funds associated with the purchase from the gaming establishment account to the determined first quantity of pre-paid cards, wherein no more than the predetermined pre-paid card spending amount limit is transferred to any one of the determined first quantity of pre-paid cards in association with the purchase.

Additional features are described herein, and will be apparent from the following Detailed Description and the figures.

### BRIEF DESCRIPTION OF SEVERAL VIEWS OF THE DRAWINGS

FIG. 1 is an example configuration of the architecture of a plurality of different components of the system disclosed herein.

FIGS. 2A, 2B, and 2C are example graphical user interfaces displayed on a mobile device in connection with automatically issuing zero, one or more pre-paid cards and depositing funds from one or more gaming establishment accounts to one or more pre-paid cards in association with a purchase made.

### DETAILED DESCRIPTION

In various embodiments, the system disclosed herein utilizes funds associated with one or more gaming establishment accounts maintained for a user to procure one or more pre-paid cards associated with a retailer and used to complete one or more purchases of goods and/or services from the retailer. In such embodiments, to facilitate the use of pre-paid cards, the system automatically issues (if needed) one or more pre-paid cards and funds a determined quantity of pre-paid cards which are then used by the system to complete a retail purchase.

In certain embodiments, after establishing and funding a gaming establishment retail account (the funds of which, per current U.S. Treasury Department regulations, may not be convertible for cash, but may be used to pay for various retail purchases), the system disclosed herein enables a user to utilize a mobile device to facilitate the issuance and funding of one or more pre-paid cards with or using part or all of such gaming establishment retail account funds. Following the issuance and/or funding of such pre-paid cards, the system enables the user to then utilize the mobile device and the funded pre-paid cards to complete a retail purchase with a retail establishment. Accordingly, the system disclosed herein provides a mobile device facilitated transfer of funds from a gaming establishment retail account to one or more pre-paid cards and then to a retail establishment to enable the user to purchase goods and/or services from a retail establishment. As such, this system enables funds to move from different accounts within the different systems associated with a gaming establishment to one or more pre-paid cards while adhering to various financial regulations associated with such different accounts and such pre-paid cards. Such a configuration thus enables certain gaming establishments and/or retail establishments to maintain a designated classification in accordance with U.S. Treasury Department regulations without modifying the user's ability to purchase goods and/or services from the retail establishment. Such a configuration additionally encourages the use of mobile devices to facilitate the purchase of goods and/or services from a retail establishment and thus overcomes various security concerns and labor cost concerns associated with both cash-based retail transactions and ticket voucher-based retail transaction.

More specifically, in certain embodiments, in association with a user attempting to make a purchase with funds maintained in a gaming establishment account, such as a gaming establishment retail account, the system determines a quantity of pre-paid cards necessary to complete the purchase. That is, since certain regulations impose spending limits on an individual pre-paid card and since the funds on such pre-paid cards may not be converted to cash, the system disclosed herein determines, based on the amount of the attempted retail transaction and the spending limit per individual pre-paid card, a quantity of individual pre-paid cards needed to complete the attempted retail transaction. For example, if regulations impose a $2000 daily spending limit on each individual pre-paid card and a user wishes to complete a retail purchase of goods and/or services valued at $3000, the system determines that the user will need to utilize at least two pre-paid cards (e.g., one pre-paid card having a balance of at least $2000 and one pre-paid card having a balance of at least $1000) to complete the purchase of the goods and/or services valued at $3000.

In addition to determining a quantity of pre-paid cards necessary to complete the purchase, in certain embodiments, the system determines whether or not the user is already associated with the determined quantity of pre-paid cards. In these embodiments, if the user is not already associated with the determined quantity of pre-paid cards, the system automatically issues one or more pre-paid cards in association with a gaming establishment account, such as a gaming establishment retail account. In other words, if the system determines, based on the determined quantity of pre-paid cards needed to complete the attempted retail transaction and based on the quantity of any pre-paid cards previously associated with the user, that the user is in need of one or more pre-paid cards to complete the attempted retail transaction (i.e., a pre-paid card issuance event has occurred), the system proceeds with automatically issuing the requisite amount of pre-paid cards in association with the user. For example, following the determination that two pre-paid cards will be needed to complete the purchase of the goods and/or services valued at $3000, and following a determination that the gaming establishment retail account maintained for the user is already associated with one pre-paid card, the system automatically issues a second pre-paid card to the user in association with that gaming establishment retail account.

In certain embodiments, following the issuance of one or more pre-paid cards in association with a gaming establishment account maintained for a user (or alternatively upon a determination that at least the determined quantity of pre-paid cards were previously associated with the gaming establishment account maintained for the user), the system facilitates the funding of the determined quantity of pre-paid cards. In these embodiments, if one or more of the pre-paid cards lack the amount of funds necessary to complete the attempted retail transaction, the system transfers an amount of funds from one or more gaming establishment accounts to such pre-paid cards. In different embodiments, the system funds such pre-paid cards with an amount of funds maintained by a gaming establishment retail account and/or by an amount of funds maintained by one or more other gaming establishment accounts, such as a gaming establishment cashless wagering account (which, in certain embodiments, the system transfers to the gaming establishment retail account to fund the pre-paid cards). Continuing with the above example, following the issuance of a second pre-paid card necessary to complete the purchase of the goods and/or services valued at $3000, following a determination that both pre-paid cards associated with the gaming establishment retail account have a balance of $0 and following a determination that a cashless wagering account maintained for the user has a balance of $5000, the system transfers (either directly or through the gaming establishment retail account) $2000 from the cashless wagering account maintained for the user to a first pre-paid card and then transfers (either directly or through the gaming establishment retail account) $1000 from the cashless wagering account maintained for the user to a second pre-paid card. In this example, following these automatic transfers, the two pre-paid cards (i.e., the determined quantity of pre-paid cards needed to complete the requested retail transaction) collectively have $3000 (i.e., the amount needed to complete the requested retail transaction).

Following the funding of the pre-paid cards, the system utilizes the pre-paid cards to complete the transaction. In certain embodiments, as the use of funds of a pre-paid card represents a reduction to the balance of such a pre-paid card and an increase to the balance of an account associated with the retail establishment, one or more servers associated with the retail establishment interact with one or more servers of a banking system that maintains an account that backed the funds transferred to the pre-paid card and using the banking network, facilitates a transfer of funds from the account that backed the funds transferred to the pre-paid card to a banking account associated with the retail establishment. In certain other embodiments, as the use of funds of a pre-paid card represents a reduction to the balance of such a pre-paid card and an increase to the balance of an account associated with the retail establishment, one or more servers associated with the gaming establishment retail system that maintain the gaming establishment retail account interact with one or more servers of a banking system that maintains an account that backed the funds transferred to the pre-paid card and using the banking network, facilitates a transfer of funds from the account that backed the funds transferred to the pre-paid card to a banking account associated with the retail establishment. Accordingly, in these embodiments, the system disclosed herein employs the automatic issuance and/or funding of one or more pre-paid cards to enable a user to safely make one or more retail purchases (via the elimination of the user having to potentially carry large sums of cash to the retail establishment to complete the purchase) while enabling the system that maintains various accounts for a user and/or the retail establishment that enables a user to draw funds from these accounts to purchase goods and/or services to maintain a designated regulatory status.

### System Accounts

In various embodiments, the system disclosed herein includes various components or sub-systems that are each associated with or otherwise maintain one or more electronic or virtual accounts. In these embodiments, the various accounts maintained for a user collectively form a resort or enterprise account (i.e., a gaming establishment fund management account) for the user. That is, the collection of cashless wagering accounts (i.e., cashless wagering wallets) and gaming establishment retail accounts (i.e., gaming establishment retail wallets) associated with or otherwise maintained for a user, such as a player, collectively form a resort or enterprise account (i.e., an integrated resort or gaming establishment fund management wallet) that the user, such as a player, may access to transfer funds and/or view balance information amongst the various accounts associated with or otherwise maintained for the player or user. As such, the system includes one or more gaming establishment fund management systems that are each associated with or otherwise maintain one or more gaming establishment fund management accounts for a user.

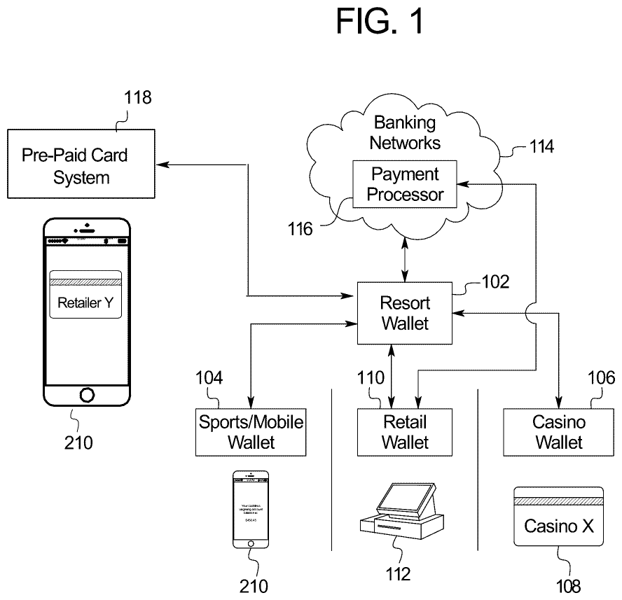

In various embodiments, the gaming establishment fund management system includes one or more cashless wagering systems that are each associated with or otherwise maintain one or more cashless wagering accounts. In certain embodiments, the gaming establishment fund management system includes a first cashless wagering system that maintains a first cashless wagering account, wherein a user utilizes a mobile device application running on a mobile device to facilitate the electronic transfer of any funds between this first cashless wagering account and an electronic gaming machine (“EGM”). For example, as seen in FIG. 1, the resort wallet 102 includes or is otherwise in communication with a Sports/Mobile Wallet 104 (i.e., a first cashless wagering account maintained by a first cashless wagering system) accessible via the mobile device 210 running a mobile device application as described herein.

In certain embodiments, the gaming establishment fund management system additionally or alternatively includes a second cashless wagering system that maintains a second cashless wagering account associated with a physical instrument, such as a user issued magnetic striped card. In these embodiments, a user utilizes the physical instrument (e.g., via inserting the card into a player tracking unit associated with an EGM) to facilitate the electronic transfer of any funds between this second cashless wagering account and the EGM. Continuing with the example, as seen in FIG. 1, the resort wallet 102 also includes or is otherwise in communication with a Casino Wallet 106 (i.e., a second cashless wagering account maintained by a second cashless wagering system) accessible via a physical instrument, such as a user issued magnetic striped card associated with the second cashless wagering system 108 or a mobile device associated with the second cashless wagering system.

In various embodiments, in addition to or an alternative of maintaining one or more cashless wagering accounts via one or more cashless wagering systems, the gaming establishment fund management system includes one or more gaming establishment retail systems that each maintain one or more gaming establishment retail accounts. Such a gaming establishment retail account (i.e., a gaming establishment retail wallet) of a gaming establishment retail system integrates with various retail point-of-sale systems throughout the gaming establishment to enable users to purchase goods and/or services via the user's gaming establishment retail account. Continuing with this example, as seen in FIG. 1, the resort wallet 102 further includes or is otherwise in communication with a Retail Wallet 110 (i.e., a gaming establishment retail account maintained by a gaming establishment retail system) accessible via a point-of-sale terminal 112 associated with a gaming establishment.

In certain embodiments, the gaming establishment fund management system is in communication with one or more external funding sources which maintain one or more external accounts for the user. In different embodiments, the external account(s) associated with the gaming establishment fund management account include, but are not limited to, one or more credit card accounts maintained by one or more financial institutions, one or more debit card accounts maintained by one or more banks or credit unions, one or more financial institution accounts, such as a brokerage account, maintained by one or more financial institutions and/or one or more third-party maintained accounts (e.g., one or more PayPal® accounts or Venmo® accounts). For example, as seen in FIG. 1, the resort wallet 102 (i.e., the gaming establishment fund management account) is in communication with a network of one or more banks or other financial institutions (i.e., the banking networks 114) which, as described below, operate to electronically transfer funds from the user's accounts maintained as such banks or financial institutions to the gaming establishment fund management system. In certain embodiments, such a network of one or more banks or other financial institutions includes or is in communication with a payment processor 116 which processes the purchases made using one or more pre-paid cards with funds drawn from an account linked or otherwise associated with the gaming establishment retail account maintained by a gaming establishment retail system.

In certain embodiments, the gaming establishment fund management system includes a pre-paid card system. In certain other embodiments, the gaming establishment fund management system is additionally or alternatively in communication with an external pre-paid card system. In these embodiments, the pre-paid card system includes one or more servers which store, in one or more databases, pre-paid card identification information associated with each pre-paid card created by the pre-paid card system, such as identifying information, value information, and/or activity information. In these embodiments, a user utilizes a mobile device application running on a mobile device to facilitate the funding of one or more pre-paid cards with an amount of funds maintained in association with one or more gaming establishment accounts to complete one or more retail purchases of goods and/or services. For example, as seen in FIG. 1, the gaming establishment fund management system includes a pre-paid card system 118 which, as described below, utilizes one or more pre-paid cards accessible via the mobile device 210 running a mobile device application to complete one or more retail purchases.

It should be appreciated that while illustrated as the gaming establishment fund management system including or being in communication with one or more external funding sources and/or one or more re-paid card systems, in different embodiments, any component or sub-system described herein can include or be in communication with one or more external funding sources and/or and pre-paid card systems. For example, the gaming establishment retail system which maintains one or more gaming establishment retail accounts in association with a user includes or may be in communication with a pre-paid card system. It should be further appreciated that in different embodiments, the system utilizes a mobile device running a mobile device application, a kiosk, an EGM, a remote host controller service window displayed by an EGM and/or a gaming establishment interface to facilitate the transfer of funds between one or more gaming establishment accounts and a third-party account, between one or more gaming establishment accounts and a pre-paid card system and/or between different gaming establishment accounts disclosed herein.

In certain embodiments (not shown), the gaming establishment fund management system (which maintains a gaming establishment fund management account or resort wallet for a user) is in communication with one or more credit systems that each issue the user one or more lines of credit or markers and/or one or more credit reporting/credit risk systems that monitor and report on various accounts associated with the user. It should be appreciated that while described as the gaming establishment fund management system being in communication with one or more credit systems and/or one or more credit reporting/credit risk systems, in different embodiments, any component or sub-system described herein can be in communication with one or more credit systems and/or one or more credit reporting/credit risk systems.

### Funding Gaming Establishment Retail Account

In various embodiments, prior to transferring any funds from a gaming establishment retail account to a pre-paid card to complete a retail purchase of goods and/or services, an amount of funds must first be established or otherwise deposited in a gaming establishment retail account.

In various embodiments, a gaming establishment retail account is part of a gaming establishment retail system. In these embodiments, the gaming establishment retail account is a retail account with a balance or a pre-paid access account which, per current regulations from the U.S. Treasury Department Financial Crimes Enforcement Network (“FinCEN”), cannot be convertible to cash and can only be used for the purchase of pre-paid cards, goods and/or services. Such a gaming establishment retail account (i.e., a gaming establishment retail wallet) of a gaming establishment retail system integrates with various retail point-of-sale systems of various retail establishments throughout or otherwise associated with a gaming establishment to enable players/users to purchase pre-paid cards, goods and/or services via the player's gaming establishment retail account. That is, while an amount of funds deposited in a gaming establishment retail account may be used with various retail point-of-sale systems throughout the gaming establishment to enable players/users to purchase pre-paid cards, goods and/or services, such funds deposited in the gaming establishment retail account cannot be converted to cash. It should be appreciated that since certain components of the gaming establishment fund management system and/or retail establishments prefer to remain classified as non-money services businesses per current regulations, the use of one or more pre-paid cards to facilitate the purchasing of goods and/or services enables such components of the gaming establishment fund management system (e.g., the gaming establishment retail system) and/or retail establishments to bypass being classified as money services businesses while still offering retail consumers the ability to purchase goods and/or services with funds maintained in one or more gaming establishment accounts.

In certain embodiments, the system enables a user to enroll or otherwise sign up for a gaming establishment retail account via a user picking up a retail account card at various locations, such as shops, throughout the gaming establishment. In certain embodiments, the system enables a user to electronically enroll or otherwise sign up for a gaming establishment retail account via a mobile application running on a mobile device, a point-of-sale terminal, an EGM and/or a kiosk. In certain embodiments, the system enables a user to enroll or otherwise sign up for a gaming establishment retail account by adding a retail account to their existing player tracking account.

In certain embodiments, the creation of a gaming establishment retail account occurs enterprise wide upon a user (whom is not associated with a gaming establishment retail account) attempting to use an amount of funds associated with the user (i.e., funds associated with the user's resort wallet or enterprise wallet) at a first site. In these embodiments, upon the requested use of the funds of the user's resort wallet from a component of the system not otherwise linked to or associated with the user's resort wallet, the system will create an enterprise wide gaming establishment retail account associated with the requesting component of the system and one or more other components of the system (such as one or more other individual sites of future attempted purchases). In certain embodiments, the creation of a gaming establishment retail account occurs via the user attempting to use an amount of funds associated with the user (i.e., funds associated with the user's resort wallet or enterprise wallet) at an individual site which was not previously associated with the user's resort wallet or enterprise wallet. In these embodiments, upon the requested use of the funds of the user's resort wallet from a component of the system not otherwise linked to or associated with the user's resort wallet, the system will create a gaming establishment retail account associated with the requesting component of the system. For example, if a user attempts to use funds from their resort wallet at a gaming establishment retail location not previously linked to the user's resort wallet, prior to the system employing such funds to purchase one or more pre-paid cards to complete the retail transaction, the system will create a gaming establishment retail account for the gaming establishment retail location and associate the created gaming establishment retail account with the user's existing resort wallet. Such dynamic account creation provides users enhanced ease of use as they can seamlessly use their existing resort wallet at various new sites or locations within or otherwise associated with one or more gaming establishments.

In certain embodiments, a gaming establishment retail account is associated with a third-party account, such as one or more credit card accounts, one or more debit card accounts and/or one or more third-party maintained accounts (e.g., one or more PayPal® accounts or Venmo® accounts), from which funds are drawn from to fund the gaming establishment retail account. In certain embodiments, the gaming establishment retail account is associated with a gaming establishment or a group of gaming establishments, wherein the system enables the user to establish a gaming establishment retail account by a deposit of funds (such as at a kiosk). In other embodiments, the system funds the gaming establishment retail account via a mobile device electronic fund transfer, such using Apple Pay™ or Android Pay™. In various embodiments, the system utilizes a mobile device running a mobile device application, a kiosk, an EGM and/or a gaming establishment interface to facilitate this transfer of funds from a third-party account.

In certain embodiments, the system enables funds to be deposited in a gaming establishment retail account via drawing funds from a gaming establishment credit system which issues the user a line of credit or marker. In certain other embodiments, the system includes one or more gaming establishment fund management systems which are each associated with or otherwise maintain one or more gaming establishment fund management accounts for a user. In these embodiments, the gaming establishment fund management system (which maintains a gaming establishment fund management account for a user) is in communication with one or more credit systems which each issue the user one or more lines of credit or markers, wherein prior to the funds drawn from the line of credit being transferred to a gaming establishment retail account, such funds must first be transferred to or otherwise established in the gaming establishment fund management account via one or more lines of credits. In various embodiments, the system utilizes a mobile device running a mobile device application, a kiosk, an EGM and/or a gaming establishment interface to facilitate these transfer(s) of funds from the gaming establishment credit system.

In certain embodiments, the system enables funds to be deposited in a gaming establishment retail account via an EGM. In certain embodiments, the system enables a user that has an amount of cash to utilize an EGM to convert the cash to an amount deposited into a gaming establishment retail account (which is subsequently utilized to purchase pre-paid cards, goods and/or services at a retail establishment, such as a retailer associated with a gaming establishment). In other embodiments, the system enables funds to be deposited in a gaming establishment retail account via an EGM that accepts printed ticket vouchers (i.e., a bearer instrument redeemable for cash or game play on the EGM). In certain of these embodiments, the system enables a user that has one or more printed ticket vouchers to utilize an EGM to convert the printed ticket voucher to an amount deposited into a gaming establishment retail account (which is subsequently utilized to purchase pre-paid cards, goods and/or services at a retail establishment, such as a retailer associated with a gaming establishment). In certain others of these embodiments, the system enables a user that has one or more printed ticket vouchers to utilize an EGM to convert the printed ticket voucher to an anonymous virtual ticket voucher associated with a mobile device (which is subsequently utilized to purchase pre-paid cards, goods and/or services at a retail establishment, such as a retailer associated with a gaming establishment).

In certain embodiments, the system enables funds to be deposited in a gaming establishment retail account via a gaming establishment interface, such as at a casino desk. In certain embodiments, the system enables a user that has an amount of cash to utilize a gaming establishment interface, such as at a casino desk to convert the cash to an amount deposited into a gaming establishment retail account (which is subsequently utilized to purchase pre-paid cards, goods and/or services at a retail establishment, such as a retailer associated with a gaming establishment). In other embodiments, the system enables funds to be deposited in a gaming establishment retail account via a gaming establishment interface that accepts printed ticket vouchers. In certain of these embodiments, the system enables a user that has one or more printed ticket vouchers to utilize a gaming establishment interface to convert the printed ticket voucher to an amount deposited into a gaming establishment retail account (which is subsequently utilized to purchase pre-paid cards, goods and/or services at a retail establishment, such as a retailer associated with a gaming establishment). In certain others of these embodiments, the system enables a user that has one or more printed ticket vouchers to utilize a gaming establishment interface to convert the printed ticket voucher to an anonymous virtual ticket voucher associated with a mobile device (which is subsequently utilized to purchase pre-paid cards, goods and/or services at a retail establishment, such as a retailer associated with a gaming establishment).

In certain embodiments, the system enables funds to be deposited in a gaming establishment retail account via a kiosk that accepts money. In certain embodiments, the system enables a user that has an amount of cash to utilize a kiosk to convert the cash to an amount deposited into a gaming establishment retail account (which is subsequently utilized to purchase pre-paid cards, goods and/or services at a retail establishment, such as a retailer associated with a gaming establishment). In other embodiments, the system enables funds to be deposited in a gaming establishment retail account via a kiosk that accepts printed ticket vouchers. In certain of these embodiments, the system enables a user that has one or more printed ticket vouchers to utilize a kiosk to convert the printed ticket voucher to an amount deposited into a gaming establishment retail account (which is subsequently utilized to purchase pre-paid cards, goods and/or services at a retail establishment, such as a retailer associated with a gaming establishment). In certain others of these embodiments, the system enables a user that has one or more printed ticket vouchers to utilize a kiosk to convert the printed ticket voucher to an anonymous virtual ticket voucher associated with a mobile device (which is subsequently utilized to purchase pre-paid cards, goods and/or services at a retail establishment, such as a retailer associated with a gaming establishment).

In certain embodiments, the gaming establishment retail account is associated with funds associated with one or more virtual ticket vouchers. In certain embodiments, the system enables a user associated with an amount of virtual ticket vouchers to utilize an EGM, a mobile device running an application, a kiosk and/or a gaming establishment interface to convert the virtual ticket vouchers to an amount deposited into a gaming establishment retail account.

In certain embodiments, the system enables a user to fund the gaming establishment retail account independent of the mobile device and independent of the mobile device application. In certain other embodiments, the system enables a user to utilize a mobile device running a mobile device application to fund the gaming establishment retail account. More specifically and utilizing the example of a kiosk, in one embodiment, to utilize a mobile device and a kiosk to facilitate the funding of a gaming establishment retail account, the user wirelessly pairs or otherwise connects a mobile device with a kiosk. In one example embodiment, the user moves the mobile device into the range of a wireless receiver of the kiosk. The kiosk and the launched or activated mobile device application of the mobile device negotiate a secure, authenticated connection with the proper functionality, versions and security settings. It should be appreciated that the kiosk wirelessly connects with the mobile device running the mobile device application in the same or similar fashion to how a mobile device is paired or connected with an EGM as described herein.

After connecting the mobile device to the kiosk, the kiosk prompts the user to deposit an amount of funds into the kiosk. In one such embodiment, the kiosk prompts the user to insert one or more bills into a bill acceptor of the kiosk. In another such embodiment, the kiosk additionally or alternatively prompts the user to deposit a physical ticket voucher (associated with an amount of funds) into the kiosk. In another such embodiment, the kiosk additionally or alternatively prompts the user to deposit a card associated with an external account, such as a credit card or debit card into the kiosk. In another such embodiment, the kiosk additionally or alternatively prompts the user to enter information associated with an external account, such as a credit card account, a PayPal® account, a Venmo® account, or a debit card account into the kiosk. In another such embodiment, the kiosk additionally or alternatively prompts the user to deposit an amount of funds into the kiosk using a mobile device electronic fund transfer, such using Apple Pay™ or Android Pay™.

In one embodiment, after a first amount of funds is accepted, such as after a first bill or unit of currency is accepted, by the kiosk, the kiosk and/or the mobile device application enable the user to transfer the deposited amount of funds (e.g., a “Load Phone Now” button) or continue to deposit additional amounts of funds with the kiosk. In certain embodiments, upon receiving an amount of funds from the user and the user indicating to transfer the deposited amount of funds in association with the mobile device application, the kiosk communicates with one or more servers, such as a gaming establishment retail server, to transfer an amount of money to a gaming establishment retail account (to be subsequently utilized to purchase pre-paid cards, goods and/or services at a retail establishment, such as a retailer associated with a gaming establishment).

It should be appreciated that while the above example embodiments are described in relation to utilizing a mobile device to facilitate the transferring one or more amounts of money or units of currency from a kiosk to a gaming establishment retail account, such example embodiments may also be used to transfer, either as an isolated transaction or as part of an operation mode of the EGM, one or more amounts of money or units of currency from an EGM to a gaming establishment retail account and/or from a gaming establishment interface, such as a casino desk, to a gaming establishment retail account.

In certain embodiments, in addition to utilizing the mobile device to facilitate the transfer of funds from a gaming establishment retail account to one or more pre-paid cards, the system utilizes a mobile device to facilitate the transfer of funds from a cashless wagering account to a gaming establishment retail account. In these embodiments, the transfer of funds from the cashless wagering account to the gaming establishment retail account occurs via one or more applications being run or executed on the mobile device. That is, the mobile device application enables the user to request that an amount of funds be transferred from the cashless wagering account to the gaming establishment retail account.

It should be appreciated that in various embodiments the system limits the transfer of funds from a cashless wagering account to a gaming establishment retail account to funds that can be redeemed for cash, such as cashable credits and/or non-restricted promotional credits. That is, to prevent a user from improperly converting non-cashable credits held in a cashless wagering account to pre-paid cards, products and/or services, the system enables the user to utilize cashable credits (i.e., credits that can be directly converted to cash) to load funds from their cashless wagering account to their gaming establishment retail account (which are then usable for pre-paid cards, goods and/or services, but not otherwise redeemable for cash). In certain embodiments, this configuration provides just-in-time funding of the gaming establishment retail account to enable the user to make purchases at different point-of-sale locations associated with the gaming establishment retail network.

Following the determination to transfer an amount of funds (in the form of cashable credits) from a cashless wagering account to a gaming establishment retail account (such as to ensure that the gaming establishment retail account has adequate funds to be transferred to one or more pre-paid cards to complete a retail transaction), the cashless wagering system determines whether to authorize the transfer of the determined amount of funds. If the cashless wagering system determines not to authorize the determined amount of funds, the cashless wagering system communicates a denial to the mobile device application, wherein the mobile device application displays a denial of fund transfer to the user.

On the other hand, if the cashless wagering system determines to authorize the determined amount of funds, the cashless wagering system updates the cashless wagering account associated with the user (to reflect a reduction of the determined amount of cashable funds) and communicates an authorization to the gaming establishment retail system. The gaming establishment retail system then increases a balance of available funds of the gaming establishment retail account by the transferred amount of funds. The mobile device application proceeds with displaying an updated gaming establishment retail account balance as well as an updated cashless wagering account balance.

In certain embodiments, the system includes an automatic reload feature wherein if a gaming establishment retail account falls below a threshold level, the system automatically transfers an amount from the external account, the cashless wagering account and/or the gaming establishment account to the gaming establishment retail account. It should be appreciated that, in certain embodiments, the system enables the user to enable or disable such an automatic reload feature.

It should be appreciated that while described in association with funding a gaming establishment retail account, any suitable gaming establishment account, such as a gaming establishment fund management account and/or a cashless wagering account may be funded as the gaming establishment retail account is funded.

### Linking Mobile Device to Point-of-Sale Terminal to Make Purchase Via Pre-Paid Card

In various embodiments, after establishing an amount of funds in a gaming establishment retail account, but prior to enabling a player to take any action related to making a purchase of goods and/or services using the funds in the gaming establishment retail account via the procurement of one or more pre-paid cards, a pairing or linkage occurs between the mobile device and a point-of-sale terminal (“POST”) (or a component of a gaming establishment management system and/or a component of a gaming establishment retail system located inside the POST (i.e., a component of the POST)). The pairing or linkage between the mobile device and the POST occurs via one or more applications being run or executed on the mobile device.

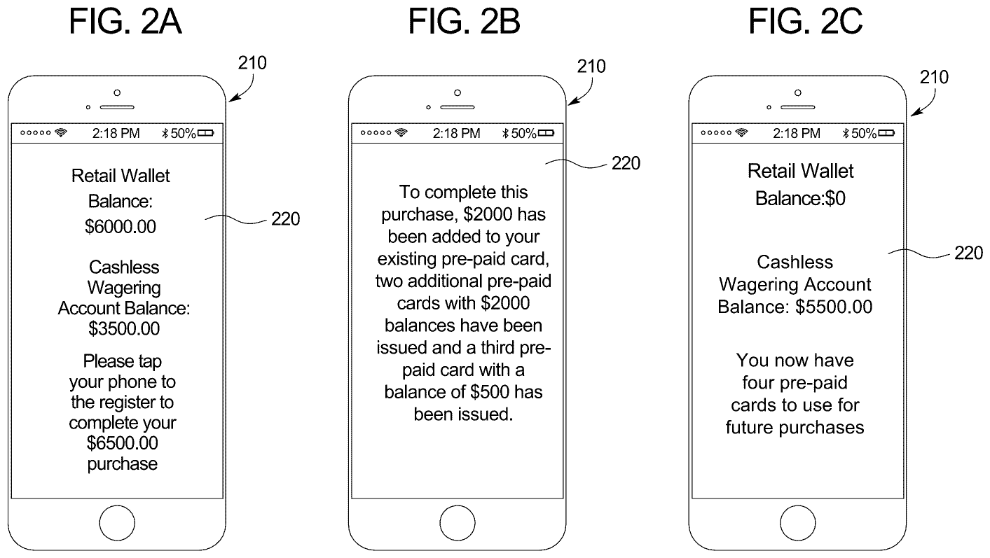

In certain embodiments, following the above-described establishment of a gaming establishment retail account and the above-described funding of the gaming establishment retail account, the user presents a retail wallet identity (i.e., a physical card associated with the gaming establishment retail account or a mobile device running a mobile device application associated with the gaming establishment retail account) at an applicable terminal of the point-of-sale system within or otherwise associated with the gaming establishment for the purchase of goods and/or services. For example, to make a purchase of goods and/or services, the mobile device application prompts the user to cause the mobile device to engage the POST, such as prompting the user to tap the mobile device to a designated portion of the POST (or otherwise moving the mobile device to within a designated distance of a designated location of the POST). For example, as seen in FIG. 2A, to make a purchase of goods and/or services for $6500.00 and upon launching the application on the mobile device 210, the mobile device application 220 displays that the user has a $6000 in their gaming establishment retail account (i.e., the displayed $6000 Retail Wallet Balance) and $3500 in their gaming establishment cashless wagering account (i.e., the displayed Cashless Wagering Account Balance) and instructs the user to tap the mobile device to the register (i.e., the point of sale terminal) to complete the $6500.00 purchase.

In certain embodiments wherein the retail wallet identity utilizes a mobile device application associated with a gaming establishment retail account, the mobile device application utilized is a location based digital wallet enabled application, such as a Passbook-enabled or Wallet-enabled application, which is accessible when the user enters a gaming establishment and/or the retail establishment. In certain embodiments, the mobile device application utilized is downloaded to the mobile device from an application store. In certain embodiments, the mobile device application utilized is downloaded to the mobile device from one or more websites affiliated with the gaming establishment and/or the retail establishment (which are accessible directly by the user and/or by a link opened when the user scans a QR code associated with the POST).

In certain embodiments wherein the retail wallet identity utilizes a mobile device application associated with a gaming establishment retail account, after a user has opened an application on a mobile device and selected an action to be performed, the system determines if the mobile device application is associated with an active authorization token previously created by the system. In these embodiments, an authorization token is a time-based token which expires after a designated period of time and which is associated with an additional level of user authentication beyond a user's application username and application password.

If the system determines that the application is not associated with an active authorization token previously created by the system, the mobile device application prompts the user to provide identifying information, such as a personal identification number or biometric identifier. The mobile device application stores the provided identifying information as mobile device encrypted data. Following the user providing identifying information, the mobile device application prompts the user to cause the mobile device to engage the POST (or a component of the POST), such as prompting the user to tap the mobile device to a designated portion of the POST. It should be appreciated that any reference herein to a user tapping the mobile device to a designated portion of the POST (or a component of the POST) may or may not include the user pressing a fingerprint scanner (if the mobile device is equipped with such a fingerprint scanner) while concurrently engaging the POST (or a component of the POST). In other embodiments, the mobile device application verifies the identifying information of the user by communicating with a verification/authentication server over one or more wireless communication protocols, such as WiFi protocol, a cellular communication protocol (e.g., 3G or LTE), to obtain the active authorization token.

In certain embodiments, following the user causing the mobile device to engage the POST (e.g., the user taps the mobile device to designated location(s) of the POST), the mobile device application communicates, via a wireless communication protocol, the provided identifying information and the requested action to be performed to the POST (or to a component associated with the POST). For example, upon the user tapping the mobile device to a designated location of the POST (or otherwise moving the mobile device to within a designated distance of the designated locations of the POST), the mobile device application sends the identifying information and the requested action to a component of a gaming establishment management system and/or a component of a gaming establishment retail system located inside the POST (i.e., a component of the POST).

Following the communication of the identifying information and the requested action to the POST (or a component associated with the POST), the system determines if the identifying information is valid. For example, a designated system component configured to operate with the gaming establishment retail system determines whether the identifying information is valid.

If the system determines that the identifying information is invalid, the system communicates an invalid identifying information response to the mobile device. For example, an identifying information status message is communicated to the mobile device which reports whether the identifying information is valid or invalid. The mobile device application then displays one or more messages regarding the invalid identifying information and prompts the user to provide identifying information, such as a personal identification number or biometric identifier. In certain such embodiments, if the mobile device receives a communication that the identifying information is invalid (or alternatively in association with the initial creation of a token) and if the mobile device includes a fingerprint scanner, the mobile device application prompts the user to press the fingerprint scanner while engaging the POST, such as tapping the mobile device to a designated portion of the POST.

On the other hand, if the system determines that the identifying information is valid, the system creates an authorization token. The system associates the authorization token with a timestamp of when the authorization token will expire. In certain embodiments, a cashless system includes a key distribution center which generates a session key to encrypt all cashless messages. The session key is rotated periodically at a configurable rate from 1 hour to 24 hours. In these embodiments, the system utilizes this session key to sign the token data and create a token. As such, the token time-to-live will be less than or equal to the session key rotation period. In other embodiments, such authorization tokens are managed utilizing software (and not a key distribution center).

Following the creation of an authorization token, the system communicates the created authorization token to the mobile device, such as via one or more messages including the created authorization token, for storage by the mobile device application and proceeds with executing one or more of the requested actions and communicating a requested action response to the mobile device. For example, upon the creation of the authorization token, the component of a gaming establishment management system located inside the POST (i.e., a component of the POST), communicates the created authorization token to the mobile device and proceeds with executing or otherwise initiating the execution of the requested action.

On the other hand, following a determination that the mobile device application is associated with a previously created and stored authentication token, the mobile device application prompts the user to cause the mobile device to engage the POST, such as prompting the user to tap the mobile device to a designated portion of the POST.

Following the user causing the mobile device to engage the POST (e.g., the user taps the mobile device to a designated location of the POST), the mobile device application communicates, via a wireless communication protocol, the previously stored authorization token and the requested action to be performed to the POST (or to a component associated with the POST). For example, upon the user tapping the mobile device to a user tracking card reader or other designated location(s) of the POST, the mobile device application sends the stored authorization token and the requested action to a component of a gaming establishment management system and/or a component of a gaming establishment retail system located inside the POST (i.e., a component of the POST).

Following the communication of the stored authorization token and the requested action to the POST or a component associated with the POST, the system determines if the communicated authorization token is still valid. For example, a system component configured to operate with a gaming establishment retail system determines whether the authorization token is valid (i.e., active and non-expired).

If the system determines that the communication authorization token is invalid, the system communicates an invalid authorization token response to the mobile device. The mobile device application then displays one or more messages regarding the invalid authorization token and prompts the user to provide identifying information, such as a personal identification number or biometric identifier, to obtain another authentication token.

On the other hand, if the system determines that the stored authorization token is valid, the system proceeds with executing the requested action. For example, upon the determination that the communicated authorization token is valid, the component of a gaming establishment management system located inside the POST proceeds with executing the requested action and communicates a requested action response to the mobile device.

In certain embodiments, following the presentation of the retail wallet identity to the POST and upon receiving data or information regarding the retail wallet identity, the point-of-sale system then communicates with the gaming establishment retail wallet system to confirm that the gaming establishment retail account has adequate funds (or access to adequate funds from other accounts maintained for the user) for the intended purchase. If the gaming establishment retail wallet system confirms the presence of adequate funds in the gaming establishment retail account (and/or the presence of adequate funds in other accounts maintained for the user which can be transferred to the gaming establishment retail account), the gaming establishment retail wallet system determines a quantity of pre-paid cards necessary to complete the intended purchase. That is, since certain regulations impose spending limits on an individual pre-paid card and since the funds on such pre-paid cards may not be converted to cash, the system disclosed herein determines, based on the amount of the intended purchase and the spending limit per individual pre-paid card, a quantity of individual pre-paid cards needed to complete the attempted retail transaction. Put differently, while the system disclosed herein automatically issues zero, one or more pre-paid cards in association with the purchase of goods and/or services, since funds transferred to such pre-paid cards cannot be converted to cash (and rather are required to be used for purchases only), the system determines the minimum amount of pre-paid cards (when factoring in jurisdictional spending limits) necessary for the intended purchase of goods and/or services. For example, if regulations impose a $2000 daily spending limit on each individual pre-paid card and a user wishes to complete a retail purchase of goods and/or services valued at $6500, the system determines that the user will need to utilize at least four pre-paid cards (e.g., three pre-paid cards each having a balance of at least $2000 and one pre-paid card having a balance of at least $500) to complete the purchase of the goods and/or services valued at $6500.

Following the determination of the quantity of pre-paid cards necessary to complete the purchase, the system determines whether or not the user is already associated with the determined quantity of pre-paid cards. That is, since pre-paid cards may be reusable and reloaded with additional funds, rather than issuing the user one or more pre-paid cards in association with each attempted retail purchase, the system determines whether or not the gaming establishment retail account associated with the user already has access to the determined quantity of pre-paid cards needed to complete the purchase.

If the system determines that the user's gaming establishment retail account is already associated with a set of pre-paid cards greater than or equal to the determined quantity of pre-paid cards necessary to complete the purchase, the system automatically selects the determined quantity of pre-paid cards necessary to complete the purchase from the set of pre-paid cards previously associated with the gaming establishment retail account maintained for the user. For example, if the cost of the intended purchase is $6500.00 and the system determines that the user already has five pre-paid cards associated with the gaming establishment retail wallet system from past retail activities (and each of the five pre-paid cards has zero activity for the day), the system selects four of the existing pre-paid cards (i.e., the determined quantity of pre-paid cards needed to complete the purchase) to use for the intended purchase.

On the other hand, if the user is not already associated with the determined quantity of pre-paid cards, the system determines the quantity of pre-paid cards needed to be issued to the user such that the user is associated with the determined quantity of pre-paid cards needed to complete the purchase. In other words, the system determines the number of pre-paid cards to be issued to the user which, when combined with any pre-paid cards previously associated with user, form the determined quantity of pre-paid cards necessary for the requested transaction. For example, if the cost of the intended purchase is $6500.00 and the system determines that the user already has one pre-paid card associated with the gaming establishment retail wallet system from past activities (and that one pre-paid card has zero activity for the day), the system determines that three additional pre-paid cards need to be issued to bring the total quantity of pre-paid cards associated with the gaming establishment retail wallet system to four pre-paid cards (i.e., the determined quantity of pre-paid cards needed to complete the purchase). In another example, if the cost of the intended purchase is $1500.00 and the system determines that the user has no pre-paid cards in the gaming establishment retail wallet system from past activities, in view of the $2000.00 daily spending limit per pre-paid card, the system determines that one pre-paid card will need to be issued to complete the intended purchase.

Following the determination of the quantity of pre-paid cards need to be issued to bring the total quantity of pre-paid cards associated with the gaming establishment retail wallet equal to the determined quantity of pre-paid cards needed to complete the purchase, the system automatically issues that determined quantity of pre-paid cards. In other words, if the system determines, based on the determined quantity of pre-paid cards needed to complete the attempted retail transaction and based on the quantity of any pre-paid cards previously associated with the user, one or more pre-paid cards are needed to complete the attempted retail transaction (i.e., a pre-paid card issuance event has occurred), the system proceeds with automatically issuing the requisite amount of pre-paid cards. Continuing with the above-example, after determining that three additional pre-paid cards are needed to bring the total quantity of pre-paid cards in the gaming establishment retail wallet system to four pre-paid cards (i.e., the determined quantity of pre-paid cards needed to complete the purchase), the system automatically issues the three additional pre-paid cards such that four pre-paid cards are associated with the gaming establishment retail wallet maintained for the user.

Following the issuance of one or more pre-paid cards needed to complete the purchase or upon the automatic selection of the determined quantity of pre-paid cards necessary to complete the purchase from the set of pre-paid cards previously associated with the gaming establishment retail account maintained for the user, the system proceeds to attempt to fund the determined quantity of pre-paid cards. In these embodiments, if one or more of the pre-paid cards collectively lack the amount of funds necessary to complete the attempted retail transaction, the system initiates a transfer of an amount of funds from one or more gaming establishment accounts to such pre-paid cards. That is, rather than using the funds in one or more gaming establishment accounts to complete the purchase (which may potentially cause the gaming establishment and/or retailer to obtain a regulatory classification which places additional administrative burdens on the retailer), the system utilizes one or more pre-paid cards to complete the purchase and thus maintain a designated regulatory classification with the gaming establishment and/or retailer.

In these embodiments, following the determination to initiate a transfer of an amount of funds from one or more gaming establishment accounts to the determined quantity of pre-paid cards, the system determines whether to authorize the transfer of the determined amount of funds. If the system determines not to authorize the determined amount of funds, the system communicates a denial of fund transfer and does not complete the purchase. On the other hand, if the system determines to authorize the determined amount of funds, one or more system components each update a gaming establishment account (to reflect a reduction of the determined amount of funds) and communicates an authorization to the retail system regarding the funding of such pre-paid cards. The retail system component then increases a balance of available funds of each of the pre-paid cards by the transferred amount of funds. In these embodiments, the retail system component which issues one or more pre-paid cards maintains one or more databases which include certain information for each issued pre-paid card, such as an identifier of that pre-paid card, a current amount of funds associated with that pre-paid card, and transaction history associated with that pre-paid card.

In certain embodiments, the system funds such pre-paid cards with an amount of funds maintained by the gaming establishment retail account. In certain embodiments, the system funds such pre-paid cards with an amount of funds maintained by another gaming establishment accounts, such as a gaming establishment cashless wagering account. In certain embodiments, the system funds such pre-paid cards with an amount of funds maintained by multiple gaming establishment accounts wherein each of such gaming establishment accounts contributes part of the amount of funds transferred to the pre-paid card(s). In certain embodiments, the system funds such pre-paid cards with an amount of funds maintained by a single gaming establishment account wherein an amount of funds from multiple gaming establishment accounts are first transferred to that single gaming establishment account and then to the determined quantity of pre-paid cards.

Following the funding of the determined quantity of pre-paid cards, the point-of-sale system then communicates with the gaming establishment retail wallet system to confirm that the pre-paid cards associated with the gaming establishment retail account has adequate funds for the intended purchase. If the gaming establishment retail wallet system indicates that the pre-paid cards associated with the gaming establishment retail account lacks adequate funds for the purchase, the point-of-sale system denies this sale transaction of the goods and/or services using the pre-paid cards associated with the gaming establishment retail account. On the other hand, if the gaming establishment retail wallet system confirms the presence of adequate funds on the pre-paid cards associated with the gaming establishment retail account, the point-of-sale system authorizes the sale of the goods and/or services and communicates data to the gaming establishment retail wallet system to deduct the price of the purchased goods and/or services from the pre-paid cards associated with the gaming establishment retail account.

In certain embodiments, as the use of funds of a pre-paid card represents a reduction to the balance of such a pre-paid card and an increase to the balance of an account associated with the retail establishment, one or more servers associated with the retail establishment interact with one or more servers of a banking system, such as payment processor 116 of FIG. 1, that maintains an account that backed the funds transferred to the pre-paid card and using the banking network, facilitates a transfer of funds from the account that backed the funds transferred to the pre-paid card to a banking account associated with the retail establishment. In certain other embodiments, as the use of funds of a pre-paid card represents a reduction to the balance of such a pre-paid card and an increase to the balance of an account associated with the retail establishment, one or more servers associated with the gaming establishment retail system that maintain the gaming establishment retail account interact with one or more servers of a banking system that maintains an account that backed the funds transferred to the pre-paid card and using the banking network, facilitates a transfer of funds from the account that backed the funds transferred to the pre-paid card to a banking account associated with the retail establishment. In these embodiments, since certain transactions utilizing pre-paid cards establish obligations from the entity which funded the pre-paid cards to the entity which accepts the pre-paid card in exchange for goods and/or services, the gaming establishment retail system and/or retailer obtains the funds associated with the accepted pre-paid cards by communicating with one or more financial institutions (which are associated with the gaming establishment accounts which funded the pre-paid cards) to initiate a credit of an account associated with the retailer of the amount of funds used to purchase the goods and/or services via one or more pre-paid cards.

In certain embodiments, the system informs the user that one or more pre-paid cards are being used to facilitate the attempted purchase. For example, as seen in FIG. 2B, to make a purchase of goods and/or services for $6500.00 and upon determining that based on a daily spending limit of $2000 per pre-paid card, a total of four pre-paid cards are necessary (and specifically three pre-paid cards with a balance of at least $2000 and one pre-paid card with a balance of at least $500 are necessary to complete the transaction), the mobile device application 220 of the mobile device 210 displays to the user how the purchase will be structured via the use of pre-paid cards. For example, as seen in FIG. 2C, following the funding of the four pre-paid cards with funds from various gaming establishment accounts, the mobile device application 220 of the mobile device 210 displays to the user the updated balances of the various gaming establishment accounts drawn from to fund the pre-paid cards. As further seen in FIG. 2C, the mobile device application 220 of the mobile device 210 also displays to the user the quantity of pre-paid cards associated with the user's gaming establishment accounts for potential future use. In certain other embodiments, the system does not inform the user that one or more pre-paid cards are being used to facilitate the attempted purchase.

Accordingly, the system disclosed herein employs the automatic issuance and/or funding of one or more pre-paid cards to enable a user to safely make one or more retail purchases (via the elimination of the user having to potentially carry large sums of cash to the retail establishment to complete the purchase) while enabling the gaming establishment and/or the retail establishment to maintain a designated regulatory status. That is, the system disclosed herein enables a user to utilize a mobile device to facilitate the issuance and funding of one or more pre-paid cards with or using part or all of such gaming establishment retail account funds wherein following the issuance and/or funding of such pre-paid cards, the system enables the user to then utilize the mobile device and the funded pre-paid cards to complete a retail purchase with a retail establishment. Such a configuration thus enables certain gaming establishments and/or retail establishments to maintain a designated classification in accordance with U.S. Treasury Department regulations without modifying the user's ability to purchase goods and/or services from the retail establishment. Such a configuration additionally encourages the use of mobile devices to facilitate the purchase of goods and/or services from a retail establishment and thus overcomes various security concerns (via the elimination of the user having to potentially carry large sums of cash to the retail establishment to complete the purchase) and labor cost concerns associated with both cash-based retail transactions and ticket voucher-based retail transaction.

It should be appreciated that the issuance (if needed) and funding of one or more pre-paid cards to complete a retail transaction utilizes one or more components of the gaming establishment fund management system and/or the gaming establishment retail system. Such components of the gaming establishment fund management system and/or the gaming establishment retail system include at least one or more servers (which maintain one or more gaming establishment accounts for the user and facilitate the transfer of funds from such gaming establishment accounts to one or more pre-paid cards), and/or one or more pre-paid card generators (which facilitate the generation of one or more pre-paid cards for redemption at one or more POSTs to complete one or more purchases of goods and/or services). In these embodiments, such components of the gaming establishment fund management system and/or the gaming establishment retail system each include a controller including at least one processor. The at least one processor is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or fund information) via a communication interface of the controller; (2) converting signals read by an interface to a format corresponding to that used by software or memory of the component of the gaming establishment fund management system and/or the gaming establishment retail system; (3) accessing memory to configure or reconfigure parameters in the memory according to indicia read from the component of the gaming establishment fund management system and/or the gaming establishment retail system; (4) communicating with interfaces and the peripheral devices (such as input/output devices); and/or (5) controlling the peripheral devices. In certain embodiments, one or more components of the controller (such as the at least one processor) reside within a housing of the component of the gaming establishment fund management system and/or the gaming establishment retail system, while in other embodiments, at least one component of the controller resides outside of the housing of the component of the gaming establishment fund management system and/or the gaming establishment retail system.

The controller also includes at least one memory device, which includes: (1) volatile memory (e.g., RAM which can include non-volatile RAM, magnetic RAM, ferroelectric RAM, and any other suitable forms); (2) non-volatile memory (e.g., disk memory, FLASH memory, EPROMs, EEPROMs, memristor-based non-volatile solid-state memory, etc.); (3) unalterable memory (e.g., EPROMs); (4) read-only memory; and/or (5) a secondary memory storage device, such as a non-volatile memory device, configured to store software related information (the software related information and the memory may be used to store various files not currently being used and invoked in a configuration or reconfiguration). Any other suitable magnetic, optical, and/or semiconductor memory may operate in conjunction with the component of the gaming establishment fund management system disclosed herein. In certain embodiments, the at least one memory device resides within the housing of the component of the gaming establishment fund management system, while in other embodiments at least one component of the at least one memory device resides outside of the housing of the component of the gaming establishment fund management system. In these embodiments, any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one memory device is configured to store, for example: (1) configuration software, such as all the parameters and settings on the component of the gaming establishment fund management system; (2) associations between configuration indicia read from an component of the gaming establishment fund management system with one or more parameters and settings; (3) communication protocols configured to enable the at least one processor to communicate with the peripheral devices; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the component of the gaming establishment fund management system to communicate with local and non-local devices using such protocols. In one implementation, the controller communicates with other devices using a serial communication protocol. A few non-limiting examples of serial communication protocols that other devices, such as peripherals (e.g., a bill validator or a ticket printer), may use to communicate with the controller include USB, RS-232, and Netplex (a proprietary protocol developed by IGT).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the player's computer, partly on the player's computer, as a stand-alone software package, partly on the player's computer and partly on a remote computer or entirely on the remote computer or server. In the latter scenario, the remote computer may be connected to the player's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device is configured to store program code and instructions executable by the at least one processor of the component of the gaming establishment fund management system to control the component of the gaming establishment fund management system. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a user uses such a removable memory device in an component of the gaming establishment fund management system to implement at least part of the present disclosure. In other embodiments, part or all of the program code and/or the operating data is downloaded to the at least one memory device of the component of the gaming establishment fund management system through any suitable data network described above (such as an Internet or intranet).

The at least one memory device also stores a plurality of device drivers. Examples of different types of device drivers include device drivers for component of the gaming establishment fund management system components and device drivers for the peripheral components. Typically, the device drivers utilize various communication protocols that enable communication with a particular physical device. The device driver abstracts the hardware implementation of that device. For example, a device driver may be written for each type of card reader that could potentially be connected to the component of the gaming establishment fund management system. Non-limiting examples of communication protocols used to implement the device drivers include Netplex, USB, Serial, Ethernet, Firewire, I/O debouncer, direct memory map, serial, PCI, parallel, RF, Bluetooth™, near-field communications (e.g., using near-field magnetics), 802.11 (WiFi), etc. In one embodiment, when one type of a particular device is exchanged for another type of the particular device, the at least one processor of the component of the gaming establishment fund management system loads the new device driver from the at least one memory device to enable communication with the new device. For instance, one type of card reader in the component of the gaming establishment fund management system can be replaced with a second different type of card reader when device drivers for both card readers are stored in the at least one memory device.

In certain embodiments, the software units stored in the at least one memory device can be upgraded as needed. For instance, when the at least one memory device is a hard drive, new parameters, new settings for existing parameters, new settings for new parameters, new device drivers, and new communication protocols can be uploaded to the at least one memory device from the controller or from some other external device. As another example, when the at least one memory device includes a CD/DVD drive including a CD/DVD configured to store options, parameters, and settings, the software stored in the at least one memory device can be upgraded by replacing a first CD/DVD with a second CD/DVD. In yet another example, when the at least one memory device uses flash memory or EPROM units configured to store options, parameters, and settings, the software stored in the flash and/or EPROM memory units can be upgraded by replacing one or more memory units with new memory units that include the upgraded software. In another embodiment, one or more of the memory devices, such as the hard drive, may be employed in a software download process from a remote software server.

In some embodiments, the at least one memory device also stores authentication and/or validation components configured to authenticate/validate specified component of the gaming establishment fund management system components and/or information, such as hardware components, software components, firmware components, peripheral device components, user input device components, information received from one or more user input devices, information stored in the at least one memory device, etc.

In certain embodiments, the peripheral devices include several device interfaces, such as, but not limited to: (1) at least one output device including at least one display device; (2) at least one input device (which may include contact and/or non-contact interfaces); (3) at least one transponder; (4) at least one wireless communication component; (5) at least one wired/wireless power distribution component; (6) at least one sensor; (7) at least one data preservation component; (8) at least one motion/gesture analysis and interpretation component; (9) at least one motion detection component; (10) at least one portable power source; (11) at least one geolocation module; (12) at least one user identification module; (13) at least one user/device tracking module; and (14) at least one information filtering module.

### Mobile Device/POST Communications

As indicated above, in various embodiments, one or more actions occur between a POST (or one or more other components of the gaming establishment retail system and one or more components of the gaming establishment fund management system) and a mobile device via one or more wireless communication protocols between the POST and the mobile device.

In certain embodiments, the communication with the mobile device can occur through one or more wireless interfaces of the POST. In one embodiment, the wireless interface is integrated into the cabinet of the POST and the POST processor is configured to communicate directly with and send control commands to the wireless interface. In another embodiment, the wireless interface is integrated into a device mounted to and/or within the POST cabinet, such as a user tracking unit or a user identification device of a user tracking unit. In certain embodiments where the wireless interface is embedded in a secondary device, such as a user tracking unit, the POST processor sends control commands to control the wireless interface via a secondary controller.

In certain embodiments disclosed herein, the wireless interface implements a near field communication (NFC) protocol to facilitate the insertion and removal of an electronic user tracking card (i.e., the logging in and logging out of the user from the user tracking system) and/or the transfer of funds between a cashless wagering account maintained for a user and an POST.

In certain embodiments which utilize the NFC implementation, the mobile device application registers a mobile device application with one or more processors of the mobile device. In these embodiments, when the mobile device is detected by an NFC reader of a component of a gaming establishment management system and/or a component of a gaming establishment retail system located inside the POST, the component of the gaming establishment management system located inside the POST communicates one or more data messages to the mobile device (or to one or more servers which then communicate such data messages to the mobile device). Such data messages are commands generated by the component of the gaming establishment management system located inside the POST when the mobile device is detected in the NFC reader field. The processor of the mobile device communicates the data message to the mobile device application. The mobile device application responds, such as communicating a triggering message, and a communication channel is opened between the component of the gaming establishment management system located inside the POST and the mobile device application (or between the component of the gaming establishment management system located inside the POST, one or more servers and the mobile device application). This open communication channel enables the component of the gaming establishment management system located inside the POST to send, though the NFC reader, additional data messages to the mobile device (or to the mobile device via one or more servers) which are responded to by the mobile device application of the mobile device. It should be appreciated that as long as the mobile device remains within the NFC field, the component of the gaming establishment management system located inside the POST is configured to communicate with the mobile device and send data, such as status updates, as necessary. However, once the mobile device is removed from the NFC field, the communication channel is closed and such status updates must be discontinued.

In other embodiments, the wireless interface implements a Wi-Fi, cellular and/or Bluetooth™ communications protocol to facilitate the communication of data between the mobile device and the POST. In such embodiments, Bluetooth™ pairing occurs when two Bluetooth devices agree to communicate with each other and establish a connection. In order to pair two Bluetooth wireless devices, a password (passkey) is exchanged between the two devices. The Passkey is a code shared by both Bluetooth devices, which proves that both users have agreed to pair with each other. After the passkey code is exchanged, an encrypted communication can be set up between the pair devices. In Wi-Fi paring, every pairing can be set up with WPA2 encryption or another type of encryption scheme to keep the transfer private. Wi-Fi Direct is an example of a protocol that can be used to establish point-to-point communications between two Wi-Fi devices. The protocol enables for a Wi-Fi device pair directly with another without having to first join a local network.

It should be appreciated that Wi-Fi, cellular or Bluetooth™ communication protocols can be used in lieu of or in combination with NFC. For instance, an NFC communication can be used to instantiate a Wi-Fi or Bluetooth™ communication between the POST, zero, one or more servers and a mobile device, such as secure pairing using one of these protocols. That is, in one embodiment, an NFC interface on an POST can be used to set-up a higher speed communication between the POST, zero, one or more servers and the NFC enabled mobile device. The higher speed communication rates can be used for expanded content sharing. For instance, a NFC and Bluetooth enabled POST can be tapped by an NFC and Bluetooth enabled mobile device for instant Bluetooth pairing between the devices and zero, one or more servers. Instant Bluetooth pairing between an POST, an NFC enabled mobile device and zero, one or more servers, can save searching, waiting, and entering codes. In another example, an POST can be configured as an NFC enabled router, such as a router supporting a Wi-Fi communication standard. Tapping an NFC enabled mobile device to an NFC enabled and Wi-Fi enabled POST can be used to establish a Wi-Fi connection between the devices and zero, one or more servers.

In certain embodiments which implement a Wi-Fi, cellular and/or Bluetooth™ communications protocol, the system utilizes one or more QR codes generated by the POST to facilitate the communication of data between the mobile device and the system. In such embodiments, the QR code is used to identify the POST that is displaying the QR code to identify the server to which the mobile device should connect. It should be appreciated that the QR code enables the system to establish a secure tunnel or path from the mobile device to the gaming establishment's Wi-Fi network and then to the gaming establishment's wired network and finally to the POST. In these embodiments, a communication tunnel wrapper (i.e., a Wi-Fi/Bluetooth™ tunnel wrapper) is utilized to establish a connection between the system and the mobile device and to transport any data messages described herein between the POST, zero, one or more servers and the mobile device.

More specifically, in certain embodiments, the user requests, via an input at the POST and/or the mobile device, the generation of a QR code by the POST. In response to the user's request, the POST or a user tracking unit displays a QR code. In certain embodiments, the QR code includes a nonce which prevents a third-party (e.g., another user) from sniping the user's login attempt. Such an on-demand QR code remains valid for a designated amount of time such that if the user does not scan the QR code within the designated amount of time, another QR code is necessary to be scanned to connect the mobile device to the POST.

In these embodiments, the user scans the QR code with the mobile device application. If the system determines that the QR code is valid (i.e., not expired), the mobile device application will connect to the system. It should be appreciated that as long as the established connection between the mobile device and the system remains active, one or more system servers and mobile device may communicate data, such as status updates, as necessary. It should be further appreciated that in association with the Wi-Fi or Bluetooth™ or mobile device network communications protocol described herein, any action requested by the user via the mobile device application does not require a new engagement between the mobile device and the POST, such as a new scanning of the QR code to send such a requested action from the mobile device to the POST (or to send a requested action from the mobile device to one or more servers and then from one or more servers to the POST).

In certain embodiments, following the scanning of a valid QR code, the mobile device application connects to one or more servers. In certain embodiments, after establishing a connection with one or more servers, the mobile device application transmits a connect command to the system. In response to receiving a connect command from the mobile device, the system sends a message to the mobile device. This message serves to encapsulate various commands between the system and the mobile device. In these embodiments, if the mobile device application does not receive this message within a designated period of time, such as within five seconds, the mobile device application displays an error message to the user and directs the user to rescan the QR code.

In addition to the connect command communicated from the mobile device application to the system, the mobile device application of these embodiments is configured to send a disconnect command to the system. Such a disconnect command functions to tear-down the connection the server. It should be appreciated that if the mobile device connection is severed before this command is received by the system, the sever sends this command on behalf of the mobile device application;

In another embodiment, the mobile device application is configured to send a trigger command to the system, such as a component of the gaming establishment management system located inside the POST. In this embodiment, the trigger command is associated with an action requested by the user. In such embodiments, when the system receives the trigger command from the mobile device application, the system will communicate the appropriate requests to the mobile device application. If the mobile device application does not receive these requests within a designated amount of time, such as five seconds, the mobile device application will display an error message to the user and enable the user to retry the requested action.

In other embodiments, the mobile device application communicates with the system through a tunnel established over the mobile device's Wi-FI network or the mobile device's network connection. In such embodiments, the mobile device application will connect to one or more system servers which use websockets secured with a transport layer security protocol. The system server operates with one or more translators, similarly using websockets secured with a transport layer security protocol to communicate data to the POST or a component of the POST.

In certain embodiments which utilize the NFC communication protocol described herein, which utilize the Wi-Fi, cellular and/or Bluetooth™ communication protocols described herein and/or which utilize any other communication protocol described herein, any action requested by the user via the mobile device application requires a new engagement between the mobile device and the POST, such as a new tap of the mobile device to a card reader or other designated location(s) of the POST. In certain other embodiments which utilize the NFC communication protocol described herein, which utilize the Wi-Fi, cellular and/or Bluetooth™ communication protocols described herein and/or which utilize any other communication protocol described herein, certain actions requested by the user via the mobile device application requires a new engagement between the mobile device and the POST, such as a new tap of the mobile device to a card reader or other designated location(s) of the POST and other actions requested by the user via the mobile device application do not require any new engagement between the mobile device and the POST.

It should be appreciated that while certain data or information pertaining to one or more of the requested actions are communicated between a POST (or a component of a POST, such as a component of a gaming establishment management system and/or a component of a gaming establishment retail system supported by or otherwise located inside the POST) and a mobile device, such data or information may additionally or alternatively be communicated: (i) between one or more servers and a mobile device via one or more wireless communication protocols, or (ii) between a POST and one or more servers via one or more wireless communication protocols and then from one or more servers to a mobile device via one or more wireless communication protocols.

It should additionally be appreciated that any functionality or process described herein may be implemented via one or more servers, a POST, one or more components of a POST (such as a component of a gaming establishment management system and/or a component of a gaming establishment retail system supported by or otherwise located inside the POST), or a mobile device application. For example, while certain data or information described herein is explained as being communicated from a POST or a component of a POST (such as a component of a gaming establishment management system and/or a component of a gaming establishment retail system supported by or otherwise located inside the POST) to a mobile device via one or more wireless communication protocols, such data or information may additionally or alternatively be communicated from one or more servers to a mobile device via one or more wireless communication protocols. Accordingly: (i) while certain functions, features or processes are described herein as being performed by a POST, such functions, features or processes may alternatively be performed by one or more servers, or one or more mobile device applications, or one or more components of the POST (such as a component of a gaming establishment management system and/or a component of a gaming establishment retail system supported by or otherwise located inside the POST), (ii) while certain functions, features or processes are described herein as being performed by one or more mobile device applications, such functions, features or processes may alternatively be performed by one or more servers, or one or more POSTs, or one or more components of the POST (such as a component of a gaming establishment management system and/or a component of a gaming establishment retail system supported by or otherwise located inside the POST), (iii) while certain functions, features or processes are described herein as being performed by one or more servers, such functions, features or processes may alternatively be performed by one or more POSTs, or one or more mobile device applications, or one or more components of the POST (such as a component of a gaming establishment management system and/or a component of a gaming establishment retail system supported by or otherwise located inside the POST)), and (iv) while certain functions, features or processes are described herein as being performed by one or more components of a POST (such as a component of a gaming establishment management system and/or a component of a gaming establishment retail system supported by or otherwise located inside the POST), such functions, features or processes may alternatively be performed by one or more POSTs, or one or more mobile device applications, or one or more servers.

### Securing Transactions Between Mobile Device and POST

While the use of a mobile device to facilitate the purchase of pre-paid cards to complete a retail transaction has many advantages described herein, certain security concerns arise when transferring fund data wirelessly between an POST and a mobile device (or between an POST and the mobile device via one or more servers). For example, a malicious person may attempt to intercept such a wireless communication and steal the funds being transferred. In view of these security concerns, certain embodiments of the present disclosure utilize a time window, such as ten seconds, in association with one or more requested actions. In one such embodiment, after receiving an initiation of an engagement of the POST with the mobile device, the POST (or a component of the POST) assigns or otherwise associates a time window with such an engagement. If one mobile device is attempted to be paired with the POST within the associated time window before an action is requested, the POST determines that only one mobile device is communicating with the POST and the POST proceeds with executing the requested action, such as a requested fund transfer as described herein. On the other hand, if more than one mobile device is attempted to be paired with the POST within the associated time window before an action is requested, the POST determines that an intruder device may be present. In such a situation, the POST cancels the requested action and/or prompts the user to reengage the POST with the mobile device.

In another such embodiment, after receiving a requested action from the mobile device, the POST assigns or otherwise associates a time window with such a requested action. Following the requested action, if one mobile device is attempted to be paired with the POST within the associated time window, the POST determines that only one mobile device is communicating with the POST and the POST proceeds with executing the requested action, such as a requested fund transfer as described herein. On the other hand, following the requested action, if more than one mobile device is attempted to be paired with the POST within the associated time window, the POST determines that an intruder device may be present. In such a situation, the POST cancels the requested action and/or prompts the user to reengage the POST with the mobile device.

It should be appreciated that in addition to thwarting an isolated attempt by an intruder to intercept a wireless fund transfer, the system is configured to identify if a device is involved in multiple attempted engagements with an POST over a designated threshold or time window. In this embodiment, such a device may be prohibited from being involved in further wireless fund transfers. For example, if multiple engagements are detected involving a single device within a twenty-four hour period, then that mobile device could be banned from participating in any future engagements. Alternatively, that device could be prevented from participating in engagements for a designated period of time, such as a cooling-off period.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Various changes and modifications to the present embodiments described herein will be apparent to those skilled in the art. For example, a description of an embodiment with several components in communication with each other does not imply that all such components are required, or that each of the disclosed components must communicate with every other component. On the contrary a variety of optional components are described to illustrate the wide variety of possible embodiments of the present disclosure. As such, these changes and modifications can be made without departing from the spirit and scope of the present subject matter and without diminishing its intended technical scope. It is therefore intended that such changes and modifications be covered by the appended claims.

The invention is claimed as follows:

1. A fund management system controller comprising:
a processor distinct from and operable with each of a point-of-sale terminal of a retail system and a component of a player tracking system associated with an electronic gaming machine; and
a memory device that stores a plurality of instructions that, when executed by the processor, cause the processor to:
responsive to a receipt of data associated an attempted purchase at the point-of-sale terminal of the retail system and following a determination to complete the attempted purchase:
determine, based on a first amount of funds associated with the purchase and a predetermined pre-paid retail card spending amount limit associated with each pre-paid retail card, a first quantity of pre-paid retail cards needed in association with the purchase, the first quantity of pre-paid retail cards being at least two pre-paid retail cards, and
responsive to a gaming establishment retail account not being associated with the determined first quantity of pre-paid retail cards and independent of any other determination to issue any additional pre-paid retail cards:
automatically issue a second quantity of pre-paid retail cards and associate the second quantity of pre-paid retail cards with the gaming establishment retail account such that, following the automatic association, the gaming establishment retail account is associated with at least the determined first quantity of pre-paid retail cards, and
cause a transfer, from a funding account, of the first amount of funds associated with the purchase to the determined first quantity of pre-paid retail cards, wherein no more than the predetermined pre-paid retail card spending amount limit is transferred to any one of the determined first quantity of pre-paid retail cards and the first amount of funds transferred to the determined first quantity of pre-paid retail cards are non-convertible to any amount of cash and not transferrable back to the funding account, and
responsive to a receipt, from the component of the player tracking system associated with the electronic gaming machine, of data associated with a requested transfer of a second amount of funds to the electronic gaming machine and following a determination that a cashless wagering account maintained by a gaming establishment cashless wagering server includes at least the second amount of funds, serially communicate data to the component of the player tracking system which enables an increase of a credit balance of the electronic gaming machine by the second amount of funds.

2. The fund management system controller of claim 1, wherein the second quantity of pre-paid retail cards equals the determined first quantity of pre-paid retail cards.

3. The fund management system controller of claim 1, wherein when executed by the processor, the instructions cause the processor to automatically transfer the first amount of funds associated with the purchase to the determined first quantity of pre-paid retail cards.

4. The fund management system controller of claim 1, wherein the funding account comprises the gaming establishment retail account.

5. The fund management system controller of claim 4, wherein when executed by the processor prior to the transfer of the first amount of funds associated with the purchase to the determined first quantity of pre-paid retail cards, the instructions cause the processor to transfer the first amount of funds associated with the purchase from the cashless wagering account to the gaming establishment retail account.

6. The fund management system controller of claim 1, wherein when executed by the processor, the instructions cause the processor to complete the purchase by communicating, to a computing device that maintains a first banking account, data that results in a transfer of the first amount of funds associated with the purchase from the first banking account associated with the gaming establishment retail account to a second banking account associated with the retail system.

7. The fund management system controller of claim 1, wherein the purchase occurs in association with gaming establishment retail account data being accessed via a mobile device application of a mobile device paired to the point-of-sale terminal of the retail system.

8. The fund management system controller of claim 1, wherein when executed by the processor as a result of the gaming establishment retail account being associated with the determined first quantity of pre-paid retail cards, the instructions cause the processor to transfer the first amount of funds associated with the purchase to the determined first quantity of pre-paid retail cards, wherein no more than the predetermined pre-paid retail card spending amount limit is transferred to any one of the determined first quantity of pre-paid retail cards.

9. The fund management system controller of claim 1, wherein the predetermined pre-paid retail card spending amount limit comprises a daily spending amount limit.

10. A fund management system controller comprising:
a processor distinct from and operable with each of a point-of-sale terminal of a retail system and a component of a player tracking system associated with an electronic gaming machine; and
a memory device that stores a plurality of instructions that, when executed by the processor, cause the processor to:
responsive to a receipt of data associated an attempted purchase at the point-of-sale terminal of the retail system and following a determination to complete the attempted purchase:
determine, based on a first amount of funds associated with the purchase and a predetermined pre-paid retail card spending amount limit associated with each pre-paid retail card, a first quantity of pre-paid retail cards needed in association with the purchase, the first quantity of pre-paid retail cards being at least two pre-paid retail cards,
determine a second quantity of pre-paid retail cards associated with a gaming establishment retail account,
responsive to the second quantity of pre-paid retail cards associated with the gaming establishment retail account being greater than the determined first quantity of pre-paid retail cards and independent of any determination by the retail system:
select the determined first quantity of pre-paid retail cards from the second quantity of pre-paid retail cards associated with the gaming establishment retail account, and
cause a transfer, from a funding account, of the first amount of funds associated with the purchase to the determined first quantity of pre-paid retail cards, wherein no more than the predetermined pre-paid retail card spending amount limit is transferred to any one of the determined first quantity of pre-paid retail cards, and the amount of funds transferred to the determined first quantity of pre-paid retail cards are non-convertible to any amount of cash and not transferrable back to the funding account,
responsive to the second quantity of pre-paid retail cards associated with the gaming establishment retail account being equal to the determined first quantity of pre-paid retail cards and independent of any determination by the retail system, cause a transfer, from the funding account, of the first amount of funds associated with the purchase to the determined first quantity of pre-paid retail cards, wherein no more than the predetermined pre-paid retail card spending amount limit is transferred to any one of the determined first quantity of pre-paid retail cards, and the amount of funds transferred to the determined first quantity of pre-paid retail cards are non-convertible to any amount of cash and not transferrable back to the funding account, and
responsive to the second quantity of pre-paid retail cards associated with the gaming establishment retail account being less than the determined first quantity of pre-paid retail cards and independent of any other determination to issue any additional pre-paid retail cards:
automatically issue a third quantity of pre-paid retail cards and associate the third quantity of pre-paid retail cards with the gaming establishment retail account such that, following the automatic association, the gaming establishment retail account is associated with the determined first quantity of pre-paid retail cards, and
cause a transfer, from the funding account, of the first amount of funds associated with the purchase to the determined first quantity of pre-paid retail cards, wherein no more than the predetermined pre-paid retail card spending amount limit is transferred to any one of the determined first quantity of pre-paid retail cards and the amount of funds transferred to the determined first quantity of pre-paid retail cards are non-convertible to any amount of cash and not transferrable back to the funding account, and
responsive to a receipt, from the component of the player tracking system associated with the electronic gaming machine, of data associated with a requested transfer of a second amount of funds to the electronic gaming machine and following a determination that a cashless wagering account maintained by a gaming establishment cashless wagering server includes at least the second amount of funds, serially communicate data to the component of the player tracking system which enables an increase of a credit balance of the electronic gaming machine by the second amount of funds.

11. The fund management system controller of claim 10, wherein the third quantity of pre-paid retail cards is equal to the determined first quantity of pre-paid retail cards.

12. A method of operating a fund management system controller, the method comprising:
responsive to a receipt of data associated with an attempted purchase at a point-of-sale terminal of a retail system that is distinct from the fund management system controller and following a determination to complete the attempted purchase, determining, by a processor operable with each of the point-of-sale terminal of the retail system and a component of a player tracking system associated with an electronic gaming machine and based on a first amount of funds associated with the purchase and a predetermined pre-paid retail card spending amount limit associated with each pre-paid retail card, a first quantity of pre-paid retail cards needed in association with the purchase, the first quantity of pre-paid retail cards being at least two pre-paid retail cards, and
responsive to a gaming establishment retail account not being associated with at least the determined first quantity of pre-paid retail cards and independent of any other determination to issue any additional pre-paid retail cards:
automatically issuing, by the processor, a second quantity of pre-paid retail cards and associating, by the processor, the second quantity of pre-paid retail cards with the gaming establishment retail account such that, following the automatic association, the gaming establishment account is associated with at least the determined first quantity of pre-paid retail cards, and
causing by the processor and from a funding account, a transfer of the first amount of funds associated with the purchase to the determined first quantity of pre-paid retail cards, wherein no more than the predetermined pre-paid retail card spending amount limit is transferred to any one of the determined first quantity of pre-paid retail cards in association with the purchase and the amount of funds transferred to the determined first quantity of pre-paid retail cards are non-convertible to any amount of cash and not transferrable back to the funding account, and
responsive to serially receiving, from the component of the player tracking system associated with the electronic gaming machine, data associated with a requested transfer of a second amount of funds to the electronic gaming machine and following a determination that a cashless wagering account maintained by a gaming establishment cashless wagering server includes at least the second amount of funds, serially communicating data to the component of the player tracking system which enables an increase of a credit balance of the electronic gaming machine by the second amount of funds.

13. The method of claim 12, wherein the second quantity of pre-paid retail cards equals the determined first quantity of pre-paid retail cards.

14. The method of claim 12, further comprising automatically transferring, by the processor, the first amount of funds associated with the purchase to the determined first quantity of pre-paid retail cards.

15. The method of claim 12, wherein the funding account comprises the gaming establishment account retail account.

16. The method of claim 15, further comprising, prior to the transfer of the first amount of funds associated with the purchase to the determined first quantity of pre-paid retail cards, transferring, by the processor, the first amount of funds associated with the purchase from the cashless wagering account to the gaming establishment retail account.

17. The method of claim 12, further comprising completing the purchase by communicating, to a computing device that maintains a first banking account, data that results in a transfer of the first amount of funds associated with the purchase from the first banking account associated with the gaming establishment retail account to a second banking account associated with the retail system.

18. The method of claim 12, wherein the purchase occurs in association with gaming establishment account data being accessed via a mobile device application of a mobile device paired with the point-of-sale terminal of the retail system.

19. The method of claim 12, further comprising, as a result of the gaming establishment retail account being associated with at least the determined first quantity of pre-paid retail cards, transferring, by the processor, the first amount of funds associated with the purchase to the determined first quantity of pre-paid retail cards, wherein no more than the predetermined pre-paid retail card spending amount limit is transferred to any one of the determined first quantity of pre-paid retail cards in association with the purchase.

20. The method of claim 12, wherein the predetermined pre-paid retail card spending amount limit comprises a daily spending amount limit.
